(19) United States
(12) Patent Application Publication
(10) Pub. No.: US 2025/0175693 A1
(43) Pub. Date: May 29, 2025

(54) VISUALIZATION AND TESTING OF RECOMMENDED CHANGES TO CAMERA CONFIGURATIONS

(71) Applicant: MOTOROLA SOLUTIONS, INC., Chicago, IL (US)

(72) Inventors: Piotr Dziedzic, Krakow (PL); Magdalena M. Bryg, Staniatki (PL); Bartlomiej Domagala, Krakow (PL); Wojciech Teterycz, Zamosc (PL); Peter L. Venetianer, McLean, VA (US); Konrad Wazl, Krakow (PL); Tomasz Wicherski, Krakow (PL)

(21) Appl. No.: 18/520,253

(22) Filed: Nov. 27, 2023

(51) Int. Cl. H04N 23/60; H04N 23/61; H04N 23/617; H04N 23/69; H04N 23/695; H04N 23/90

(52) U.S. Cl. CPC H04N 23/64; H04N 23/61; H04N 23/617; H04N 23/69; H04N 23/695; H04N 23/90

(57) ABSTRACT

A camera system includes an electronic processor configured to generate a three-dimensional scene including static assets and dynamic assets. The static assets and the dynamic assets are representative of an environment and objects within a reference video. The reference video represents a first perspective. The electronic processor is configured to animate the dynamic assets based on motions of the objects within the reference video to generate an animated scene, render a test video based on the animated scene. The test video represents a second perspective. The electronic processor is configured to generate video analytics data of the test video, generate a comparison based on the video analytics data of the test video and video analytics data of the reference video, and transform a graphical user interface according to the comparison.

### BACKGROUND

Cameras can be deployed to monitor an area. Cameras may be strategically placed to cover the area so as not to leave blind spots. For example, cameras may be placed at different angles and heights. Cameras may have operating parameters suitable for capturing clear images in various lighting conditions and/or during under various weather and environmental conditions. Since each area may have a unique layout, unique traffic patterns, unique lighting conditions, and/or unique weather and environmental conditions, the optimal configuration of cameras may be different for each area.

### BRIEF DESCRIPTION OF THE DRAWINGS

FIG. 1 is a block diagram of a video monitoring system according to some examples.

FIG. 2 is a flowchart of a process for testing recommendations for adjusting media-recording devices in a virtual, three-dimensional environment, according to some examples.

FIGS. 3A-3D are partial views of a screen of a graphical user interface generated by an analytics engine, according to some examples.

FIG. 4A-4D are partial views of another screen of the graphical user interface generated by an analytics engine, according to some examples.

FIGS. 5A-5D are partial views of another screen of the graphical user interface generated by an analytics engine, according to some examples.

In the drawings, reference numbers may be reused to identify similar and/or identical elements.

### DETAILED DESCRIPTION

Cameras are used to monitor various area and items. Video analytics can generate recommendations for camera positions and/or parameters to improve image or video capture. For example, video analytics can automatically analyze camera views to identify potential shortcomings of system setups and recommend adjustments to address these issues. For example, by identifying blind spots or areas where cameras provide insufficient detail, video analytics can recommend changes (such as changes in the number of cameras, positions of cameras, and/or parameters of cameras) to enhance coverage. However, the complexities of real-world environmental conditions can result in recommendations that are not as effective as determined based on the video analytics. Thus, it may be beneficial to test the recommendations in a virtual environment before performing costly real-world implementation. To address these and other technical challenges, systems and methods described in this specification implement, among other things, video analysis and three-dimensional rendering techniques to validate recommendations in a virtual environment before they are implemented in the real world.

For example, various implementations of the systems and methods described herein record a reference video of a scene and process the reference video to generate analytics data. The systems and methods may generate recommendations based on the video analytics. The systems and methods may process the reference video to render a three-dimensional environment representing the scene. For example, the systems and methods may process the reference video to reconstruct the three-dimensional geometry of the scene, identify objects present in the reference video, track the motion of moving objects in the reference video, and animate the dynamic assets within the three-dimensional environment based on the tracking data. The systems and methods may also generate environmental dynamics and lighting in the three-dimensional environment based on the reference video. Accordingly, the animated three-dimensional environment may be an accurate visual recreation of the scene.

The systems and methods may generate one or more virtual cameras within the three-dimensional environment based on the recommendations and render test videos from the perspective of the one or more virtual cameras. Since these rendered test videos may be accurate simulations of the recommendations implemented in the real world, the systems and methods may perform video analytics on the test videos, and the video analytics may show whether implementing the recommendations will generate an actual improvement over the reference video. The systems and methods may output the rendered test videos and/or video analytics to the user on a graphical user interface, allowing users to visualize new configurations implemented according to the recommendations before implementing them in the real world. Such techniques allow for large and complex systems of monitoring cameras deployed across complex and dynamic scenes to be quickly and readily optimized in a fully virtual environment, reducing or eliminating the wasted time and materials associated with traditional trial-and-error optimizations performed in the real world.

A camera system includes an electronic processor configured to generate a three-dimensional scene including static assets and dynamic assets. The static assets and the dynamic assets are representative of an environment and objects within a reference video. The reference video represents a first perspective. The electronic processor is configured to animate the dynamic assets based on motions of the objects within the reference video to generate an animated scene, render a test video based on the animated scene. The test video represents a second perspective. The electronic processor is configured to generate video analytics data of the test video, generate a comparison based on the video analytics data of the test video and video analytics data of the reference video, and transform a graphical user interface according to the comparison.

In other features, the electronic processor is further configured to label the objects within the reference video, track positions of the labeled objects, generate object tracking data based on the positions of the labeled objects, and animate the dynamic assets based on the object tracking data. In other features, the electronic processor is further configured to generate video analytics of the reference video and generate a recommendation based on the video analytics in response to the video analytics being below a threshold. The second perspective is determined based on the recommendation. In other features, the recommendation includes a change in a spatial position of a camera used to record the reference video and the second perspective is determined based on the change in the spatial position of the camera.

In other features, the recommendation includes a change in an optical zoom level of a camera used to record the reference video and the second perspective is determined based on the change in the optical zoom level of the camera. In other features, the recommendation includes a change in a sensor resolution of a first camera used to record the reference video and the test video simulates a recording from a second camera having the changed sensor resolution. In other features, the recommendation includes moving or removing a selected object from the reference video, the video analytics data indicates that the selected object reduces a performance of the reference video, and rendering the test video includes moving or removing a selected asset from the animated scene, the selected asset corresponding to the selected object.

In other features, the recommendation includes modifying illumination conditions of the reference video and rendering the test video includes adjusting illumination assets of the animated scene based on the recommendation. In other features, the recommendation includes updating a firmware of a camera used to record the reference video and the test video simulates a recording from the camera having the updated firmware. In other features, the recommendation includes a deployment of at least one new camera and the test video simulates a recording from the at least one new camera. In other features, the camera used to record the reference video and the at least one new camera include panning capabilities, tilting capabilities, and zooming capabilities, the at least one new camera includes upgraded operational parameters compared to the camera used to record the reference video, and the upgraded operational parameters include at least one of a camera pan range, a camera tilt range, or an optical zoom level of the at least one new camera.

In other features, the camera used to record the reference video is a single-head camera and the at least one new camera is a multi-head camera. In other features, the camera used to record the reference video includes first operational parameters, the at least one new camera includes second operational parameters, and the second operational parameters includes an increase in resolution over a resolution of the first operational parameters. In other features, the camera used to record the reference video includes first operational parameters, the at least one new camera includes second operational parameters, and the second operational parameters includes a different optical zoom level than an optical zoom level of the first operational parameters.

A computer-implemented method of generating a camera configuration includes generating, at a rendering engine, a three-dimensional scene including static assets and dynamic assets. The static assets and the dynamic assets are representative of an environment and objects within a reference video. The reference video represents a first perspective. The method includes animating, at the rendering engine, the dynamic assets based on motions of the objects within the reference video to generate an animated scene and rendering, at the rendering engine, a test video based on the animated scene. The test video represents a second perspective. The method includes generating, at an analytics engine, video analytics data of the test video, generating, at the analytics engine, a comparison based on the video analytics data of the test video and video analytics data of the reference video, and transforming, at the analytics engine, a graphical user interface according to the comparison.

In other features, the computer-implemented method includes labeling, with an object detection model, the objects within the reference video, tracking, with an object tracking model, positions of the labeled objects, and generating, with the object tracking model, object tracking data based on the positions of the labeled objects. The dynamic assets are animated based on the object tracking data. In other features, the computer-implemented method includes generating, at the analytics engine, video analytics of the reference video, and, in response to the video analytics being below a threshold, generating, at the analytics engine, a recommendation based on the video analytics. The second perspective is determined based on the recommendation.

In other features, the recommendation includes a change in a spatial position of a camera used to record the reference video and the second perspective is determined based on the change in the spatial position of the camera. In other features, the recommendation includes a change in an optical zoom level of a camera used to record the reference video and the second perspective is determined based on the change in the optical zoom level of the camera. In other features, the recommendation includes a change in a sensor resolution of a first camera used to record the reference video and the test video simulates a recording from a second camera having the changed sensor resolution.

Other examples, embodiments, features, and aspects will become apparent by consideration of this specification and accompanying drawings.

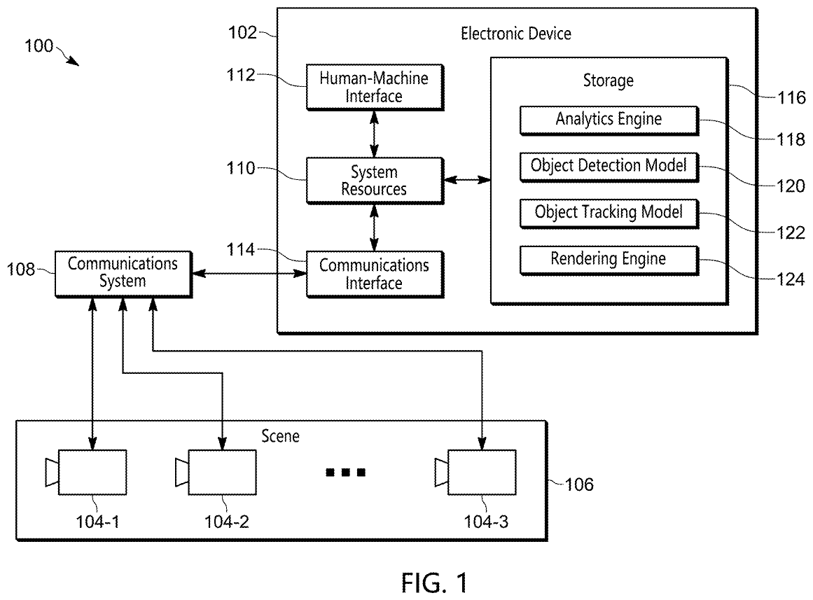

FIG. 1 is a block diagram of an example video monitoring system 100. As shown in FIG. 1, some examples of the system 100 include an electronic device 102 and one or more media-recording devices 104. While three media-recording devices 104-1, 104-2, and 104-3 are shown in FIG. 1, the system 100 may include a different number n of media-recording devices 104 (for example, more or fewer devices), including only one. In various implementations, the media-recording devices 104 include one or more monitoring cameras, such as fixed or rotating dome cameras, bullet cameras, C-mount cameras, pan-tilt-and-zoom cameras, day/night cameras, and/or thermal cameras. In some examples, the media-recording devices 104 include one or more cameras suitable for generating three-dimensional point clouds, such as lidar cameras, structured light cameras, stereo vision cameras, time-of-flight cameras, and/or multi-view stereo cameras. In some implementations, the media-recording devices 104 may be positioned to record a scene 106. Each media-recording device 104 may record media (such as videos, audio, and/or three-dimensional point clouds) of the scene 106 and communicate with the electronic device 102 via a communications system 108 (for example, by transmitting the recorded media to the electronic device 102).

The communications system 108 includes one or more networks. Examples of such networks include a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 108 includes an optical network, a local area network, and/or a global communication network, such as the Internet.

In various implementations, the electronic device 102 includes system resources 110, human-machine interfaces 112, a communications interface 114, and non-transitory computer-readable storage media, such as, for example, storage 116. In some examples, the system resources 110 include one or more electronic processors, one or more graphics processing units, volatile computer memory, non-volatile computer memory, and/or one or more system buses interconnecting the components of the electronic device 102. In some implementations, human-machine interfaces 112 include one or more input devices (such as a microphone, a push-to-talk button, a keypad, rotary knobs, buttons, a keyboard, a mouse, a touchpad, and/or a touchscreen) and/or one or more output devices (such as a display, speakers, indicator lights, and/or haptic device). In some examples, the storage 116 includes an analytics engine 118, an object detection model 120, an object tracking model 122, and/or a rendering engine 124.

The analytics engine 118 may receive media (such as videos) from the media-recording devices 104 and process the media to generate video analytics data. For example, the video analytics data may include metadata including quality scores for: objects detected in the scene 106, events detected in the scene 106, faces detected in the scene 106, and/or optical character recognition for vehicle license plates detected in the scene 106. Examples of quality scores include confidence scores (for example, probability values indicating how confident that the object has been correctly identified in the scene 106, Intersection over Union [IoU] scores measuring the overlap between predicted bounding boxes and the ground truth, precision scores indicating ratios of true positive detections to a total number of positives, recall scores indicating a ratio of true positive detections to a total number of actual positives, F1 scores indicating harmonic means of precision and recall, accuracy scores indicating ratios of correctly identified objects to all objects, etc.).

In various implementations, the analytics engine 118 may determine whether quality scores are below a threshold. In response to determining that the quality scores are below the threshold, the analytics engine 118 may generate one or more recommendations. In some examples, the recommendations may include changing the spatial position of one or more of the media-recording devices 104, changing one or more operating parameters of one or more of the media-recording devices 104, deploying one or more additional media-recording devices 104 at the scene 106, moving and/or removing one or more objects in the scene 106, and/or modifying illumination conditions of the scene 106. In various implementations, changing the spatial position includes raising or lowering a media-recording device 104, tilting the media-recording device 104, panning the media-recording device 104, and/or rotating the media-recording device 104.

In some examples, changing one or more operating parameters of a media-recording device 104 includes adjusting the field of view (for example, by adjusting the zoom or lens focal length) of the media-recording device 104, adjusting an aperture size of the media-recording device 104, adjusting a light sensitivity (such as adjusting ISO settings) of a sensor of the media-recording device 104, adjusting a resolution of the media-recording device 104, adjusting a frame rate of the media-recording device 104, adjusting a compression rate of the media-recording device 104, adjusting a bit rate of the media-recording device 104, adjusting a white balance of the media-recording device 104, adjusting backlight compensation settings of the media-recording device 104, adjusting digital noise reduction levels of the media-recording device 104, adjusting focus settings of the media-recording device 104, and/or adjusting dynamic range levels of the media-recording device 104.

In various implementations, the one or more recommendations may include updating the firmware of one or more of the media-recording devices 104. For example, updating the firmware may include adding or upgrading one or more features of the media-recording device 104. In some implementations, the features include advanced motion detection algorithms, facial recognition features, object detection features, object classification features, compression techniques, pan-tilt-zoom control enhancements, digital image stability features, audio signature detection and recognition capabilities, etc. In various implementations, the one or more recommendations may include replacing one or more of the media-recording devices 104 with a different media-recording device 104 (or adding an additional media-recording device 104) having different (for example, improved) operational parameters and/or capabilities. For example, the existing media-recording device 104 may be a static camera, while the new media-recording device 104 may be a pan-tilt-zoom camera. In some implementations, the existing media-recording device 104 may be a single-head camera, while the new media-recording device may be a multi-head camera.

The object detection model 120 may receive media (such as videos) from the media-recording devices 104 and detect objects (such as persons, vehicles, other objects of interest such as various items, etc.) in the media. In various implementations, the object detection model 120 may include one or more neural-network-based object detection models and or one or more non-neural-network-based object detection models. Neural-network-based object detection models include the you only look once (YOLO) model, the single shot multibox detector (SSD) model, faster region-based convolutional neural networks (Faster R-CNNs), EfficientDet models, RetinaNet models, CenterNet models, MobileNets with SSDLite models, and/or OpenCV deep learning models.

Non-neural-network-based object detection models including background subtraction techniques that compare each frame of the video to a model of the background to identify changes (objects moving in the scene may be detected as those parts of the frame that differ significantly from the background), optical flow algorithms that estimate the motion of objects between frames based on the apparent motion of brightness patterns, the Viola-Jones object detection framework, histogram of oriented gradients (HOG) models, scale-invariant feature transform (SIFT) models, speeded up robust features (SURF) models, template matching models, color-based detection models, and/or geometric shape matching models.

The object tracking model 122 may track objects detected by the object detection model 120 over time through a sequence of frames. In various implementations, the object tracking model 122 may include a Kalman filter, meanshift algorithms, continuously adaptive meanshitft (CAMshift) algorithms, optical flow models, particle filter models, Kuhn-Munkres algorithm models, tracking-learning-detection (TLD) models, multiple hypothesis tracking (MHD) models, Lucas-Kanade method models, Siamese networks, and/or generic object tracking using regression networks (GOTRUN) models.

While the object detection model 120 and the object tracking model 122 are illustrated as two separate models in FIG. 1, the functionality of the two models may be combined into a single model. For example, storage 116 may include a combined object detection and tracking model that detects and tracks objects through a sequence of frames. In various implementations, the combined object detection and tracking model may be implemented as a convolutional neural network (CNN), a recurrent neural network (RNN), Siamese networks, a Faster R-CNN, etc.

The rendering engine 124 may receive media (such as videos and/or three-dimensional point cloud data) from the media-recording devices 104 and generate a three-dimensional representation of the scene 106. In various implementations, the rendering engine 124 uses photogrammetry or similar techniques to reconstruct the three-dimensional geometry of the scene 106 from media such as video. For example, the rendering engine 124 extracts depth information from multiple frames to model the environment of the scene 106. In some examples, the media may include three-dimensional point cloud data, and the rendering engine 124 converts the point cloud data into a polygon mesh. The rendering engine 124 identifies moving and static objects in the scene 106 (for example, using the object detection model 120 and/or the object tracking model 122) and generates dynamic assets corresponding to the moving objects and static assets corresponding to the static objects. The rendering engine 124 may animate the dynamic assets based on the motion of the corresponding objects in the media.

The rendering engine 124 may generate textures based on the media and apply the textures to the appropriate asset in the three-dimensional environment. The rendering engine 124 may use physics engines to simulate environmental interactions (such as objects falling or cloth movement) and/or generate particle effects (for example, simulating fog, smoke, or fire) based on cues from the media. The rendering engine 124 may also estimate lighting conditions from the media and recreate them in the three-dimensional environment. For example, the rendering engine 124 applies changes in lighting present in the media to the three-dimensional environment to match the timing and/or intensity of the lighting present in the media. Thus, the rendering engine 124 generates an animated three-dimensional environment (or an animated scene) that is a recreation of the scene 106 recorded by the media-recording devices 104. The rendering engine 124 may also create one or more virtual cameras within the three-dimensional environment matching the movements and/or perspectives of the media-recording devices 104 that generated the media used to create the three-dimensional environment.

In various implementations, the rendering engine 124 may render lighting and effects based on various atmospheric and/or weather conditions. For example, the rendering engine 124 may render lighting and effects to simulate the effects or precipitation, such as rain, snow, sleet, and/or hail, etc. The rendering engine 124 may render lighting and effects to simulate the effects of cloud coverage (for example, overcast conditions), fog, smog, sandstorms, etc. In some examples, the rendering engine 124 models the position and/or intensity of the sun, moon, stars, and/or other celestial objects based on the GPS location of the scene, the time of day, the time of year, day or night, etc.

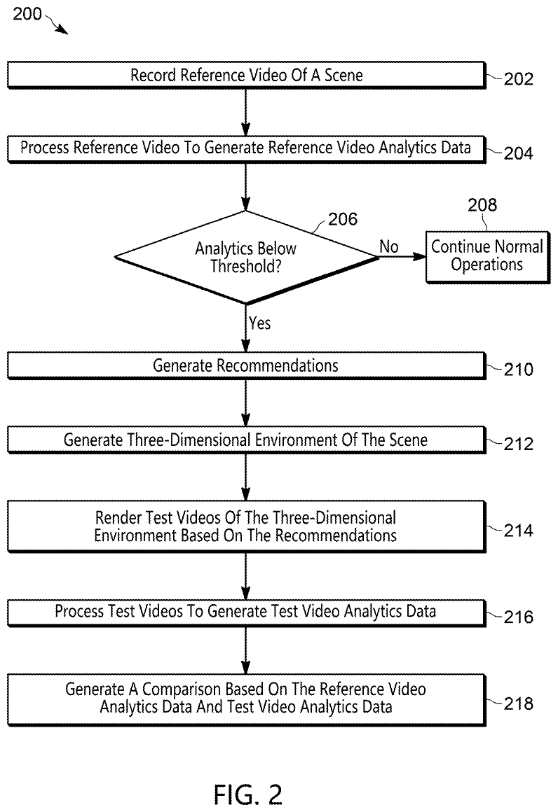

FIG. 2 is a flowchart of an example process 200 for testing recommendations for adjusting media-recording devices 104 in a virtual, three-dimensional environment. At block 202, the media-recording device 104 records a reference video of the scene 106. At block 204, the analytics engine 118 processes the reference video to generate reference video analytics data. For example, the media-recording device 104 transmits the reference video to the electronic device 102 via the communications system 108 and the analytics engine 118 processes the reference video to generate reference video analytics data according to previously described techniques. At decision block 206, the analytics engine 118 determines whether the reference video analytics data is below a threshold. In response to determining that the reference video analytics data is not below the threshold (“NO” at decision block 206), the system 100 continues normal operations at block 208. In response to determining that the reference video analytics data is below the threshold (“YES” at decision block 206), the analytics engine 118 generates recommendations at block 210. In various implementations, the analytics engine 118 generates recommendations according to previously described techniques.

At block 212, the rendering engine 124 generates an animated three-dimensional environment representing the scene 106. For example, the rendering engine 124 renders the three-dimension environment of the scene 106 from the reference video and/or additional media (such as additional videos and/or three-dimensional point cloud data) from the media-recording device 104 and/or other media-recording devices 104. In various implementations, the rendering engine 124 renders the three-dimensional environment of the scene 106 accordingly to previously described techniques. At block 214, the rendering engine 124 renders test videos of the three-dimensional environment based on the recommendations. In various implementations, the recommendation may include changing a spatial position of the media-recording device 104, and, in response, the rendering engine 124 generates a new virtual camera according to the changed spatial position and renders a test video from the perspective of the new virtual camera. In some examples, the recommendation may include changing an operating parameter (as previously described) of the media-recording device 104, and, in response, the rendering engine 124 generates a new virtual camera having the changed operating parameter and renders a test video from the perspective of the new virtual camera.

In various implementations, the recommendation may include updating the firmware (as previously described) of the media-recording device 104, and, in response, the rendering engine 124 generates a new virtual camera having the functionality of the updated firmware and renders a test video from the perspective of the new virtual camera. In some examples, the recommendation may include replacing the media-recording device 104 with a different media-recording device 104 and/or adding an additional media-recording device 104 (as previously described), and, in return, the rendering engine 124 generates one or more new virtual cameras (as appropriate) and renders one or more test videos from the perspectives of the new virtual cameras. Thus, the test video may be a virtual representation of the recommendation implemented in the real world.

At block 216, the analytics engine 118 processes the test videos generated by the rendering engine 124 at block 214 to generate test video analytics data (for example, accordingly to previously described techniques). At block 218, the analytics engine 118 generates a comparison based on the reference video analytics data and the test video analytics data. In various implementations, the analytics engine 118 outputs the comparison to a graphical user interface and renders the graphical user interface on a display of the human-machine interface 112 (for example, by transforming the graphical user interface according to the comparison and/or transforming the display according to the graphical user interface). In some examples, the comparison includes the original reference video, the test video, the reference video analytics data, and/or the test video analytics data. In various implementations, the analytics engine 118 processes the reference video analytics data and/or the test video analytics data to generate advantages and/or disadvantages associated with implementing the recommendations used to generate the virtual camera that generated the test video. In some examples, the analytics engine 118 generates advantages and/or disadvantages such as whether implementing the recommendations lead to higher object detection performance, higher face detection performance, higher video resolution, higher video quality, fewer object occlusions, etc.

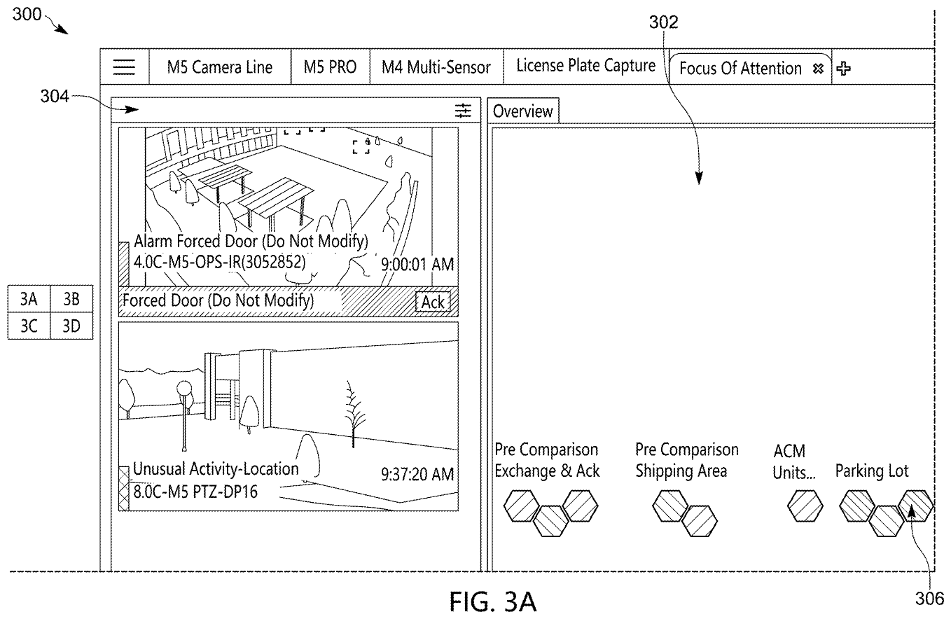

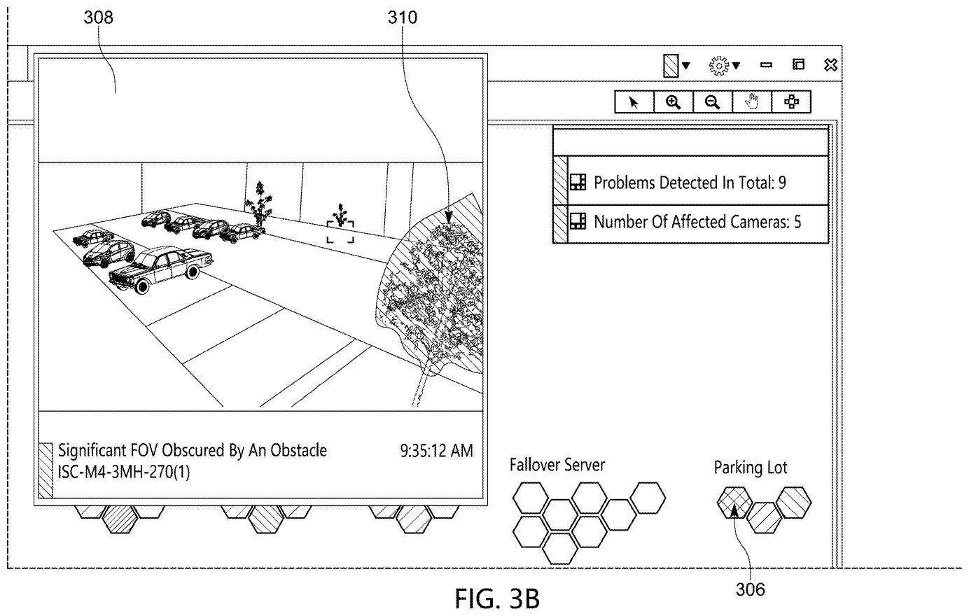

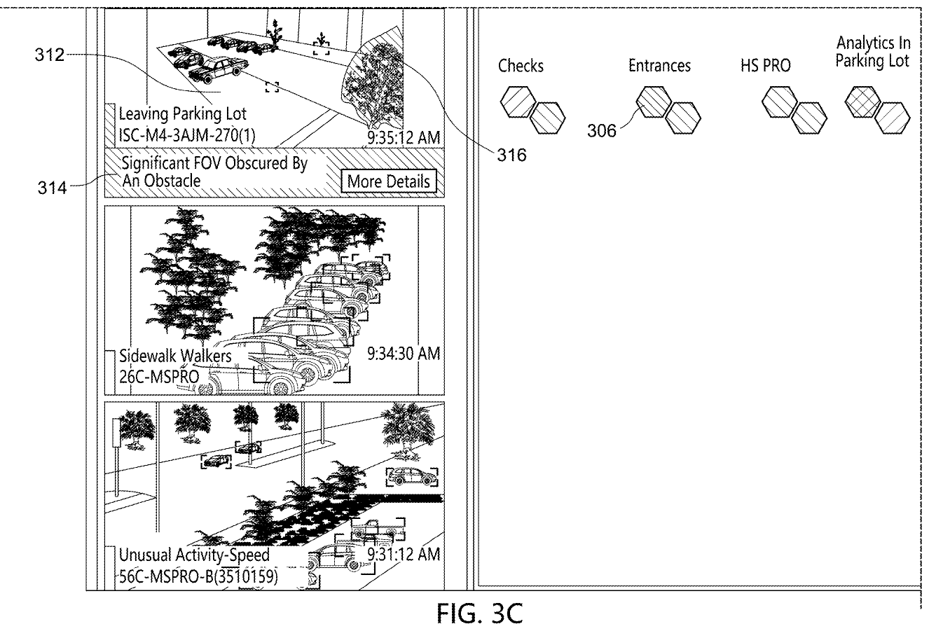

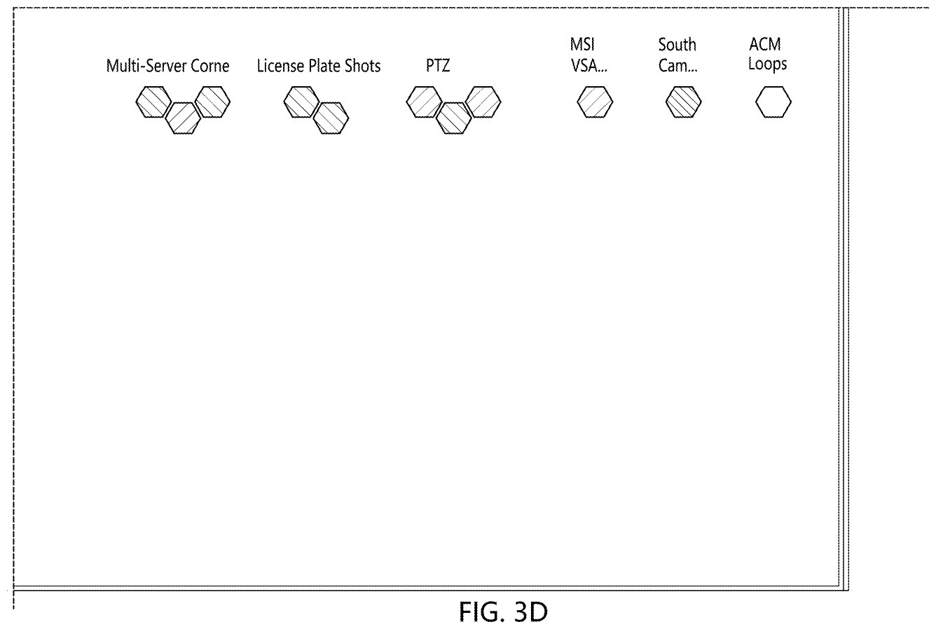

FIGS. 3A-3D are partial views of an example screen of a graphical user interface 300 generated by the analytics engine 118. In various implementations, the analytics engine 118 processes media (such as videos) generated by each of the media-recording devices 104 and generates video analytics data corresponding to each video (for example, according to previously described techniques). The analytics engine 118 identifies videos and/or areas within each video where the video analytics data falls below the threshold (indicating that the video and/or area within the video is performing poorly). The analytics engine 118 may output these poorly performing videos and/or poorly performing areas within the videos to the user via the graphical user interface 300.

For example, the graphical user interface 300 may include an overview field 302 and a recent events field 304. The overview field 302 includes one or more selectable icons 306 corresponding to videos recorded by one or more media-recording devices 104. Selectable icons 306 corresponding to videos having video analytics data falling below the threshold (e.g., poorly performing videos and/or videos with poorly performing areas) may be highlighted (for example, in a high-visibility color such as orange). In response to the user hovering a cursor over (or selecting) one of the selectable icons 306, the graphical user interface 300 generates a video preview field 308 outputting the video corresponding to the selectable icon 306. The poorly performing areas of the video may be highlighted as a highlighted area 310 (for example, in a high-visibility color such as orange) in the video preview field 308. The user may select the highlighted area 310 and, in response to the user selecting the highlighted area 310, the analytics engine may generate recommendations for improving the performance of the video (for example, at block 210 of the process 200).

In various implementations, the recent events field 304 may show one or more video preview fields 312 showing one or more videos recorded by one or more media-recording devices 104. One or more of the video preview fields 312 may correspond to videos having video analytics data falling below the threshold, and the graphical user interface 300 may highlight those video preview fields 312 with a notification field 314 (for example, in a high-visibility color such as orange). In various implementations, specific poorly performing areas of the video may be highlighted as a highlighted area 316 (for example, in a high-visibility color such as orange).

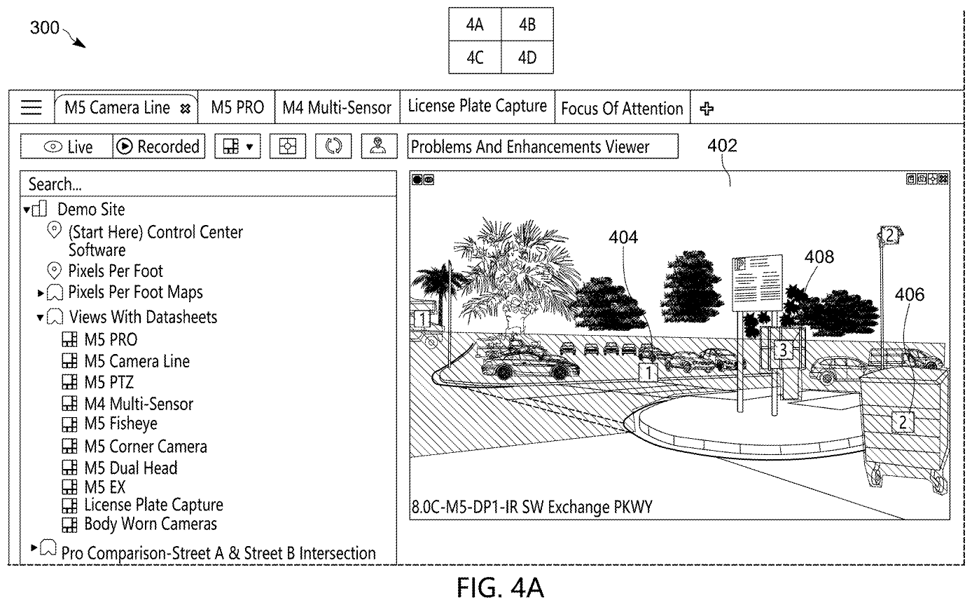

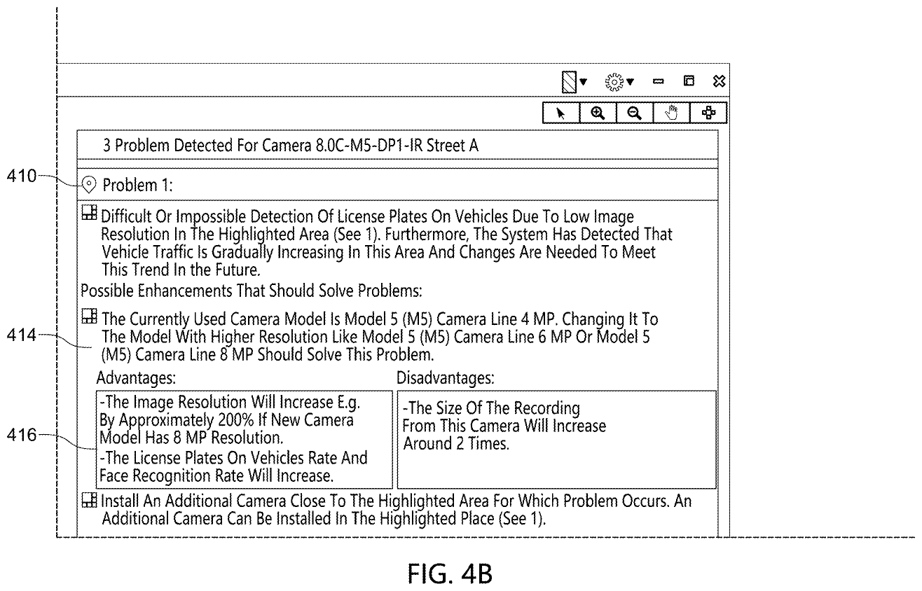

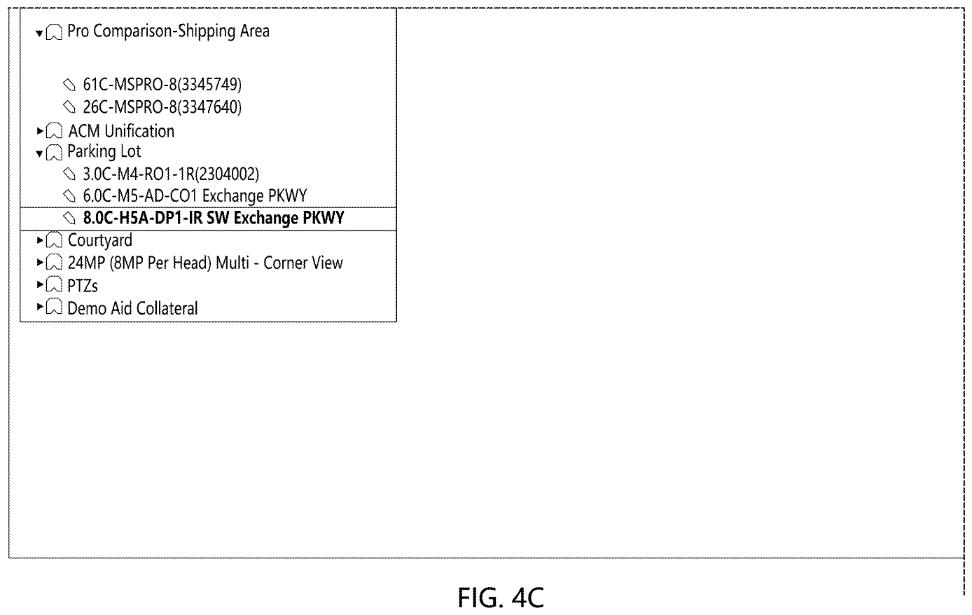

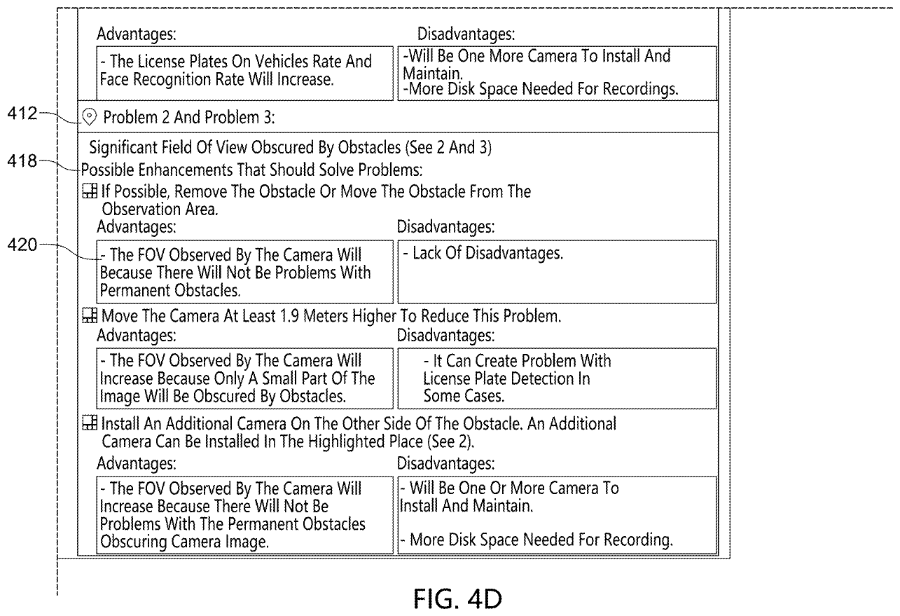

FIGS. 4A-4D are partial views of an example screen of the graphical user interface 300. As shown in FIGS. 4A-4D, the graphical user interface 300 may output a screen including a video display field 402. The graphical user interface 300 may highlight one or more specific areas, such as area 404, area 406, and area 408 corresponding to specific areas of the video having video analytics data falling below the threshold (e.g., poorly performing areas). In some examples, the area may correspond to the entire view of the video. In various implementations, the graphical user interface 300 includes one or more recommendation fields, such as recommendation field 410 and recommendation field 412. Each recommendation field may correspond to one or more highlighted areas and include recommendations for the highlighted areas and expected advantages and disadvantages associated with implementing the recommendations (generated by the analytics engine 118 accordingly to previously described techniques). For example, recommendation field 410 corresponds to area 404 and contains recommendations 414 and advantages and disadvantages 416 associated with area 404. Recommendation field 412 corresponds to both areas 406 and 408, and contains recommendations 418 and advantages and disadvantages 420 associated with both areas 406 and 408.

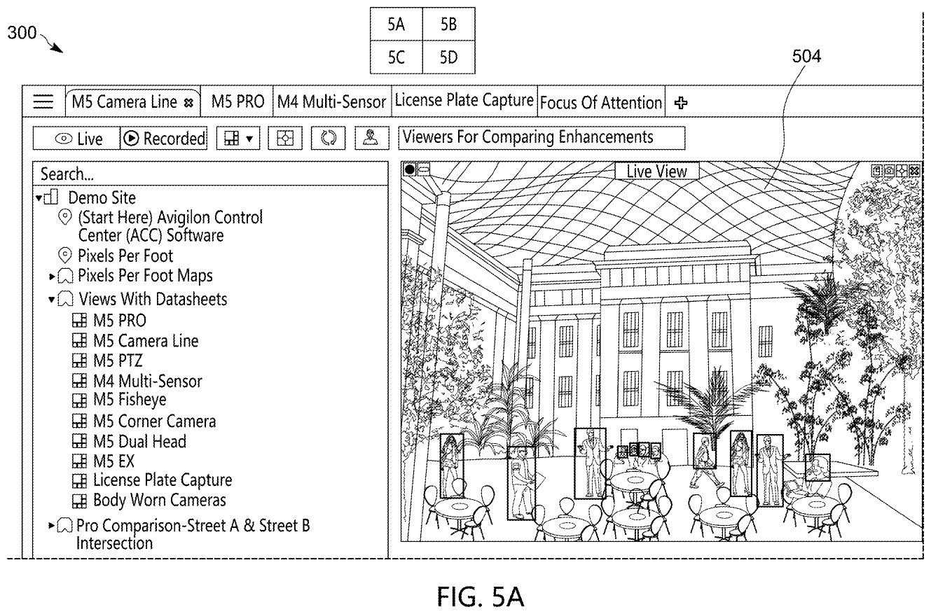

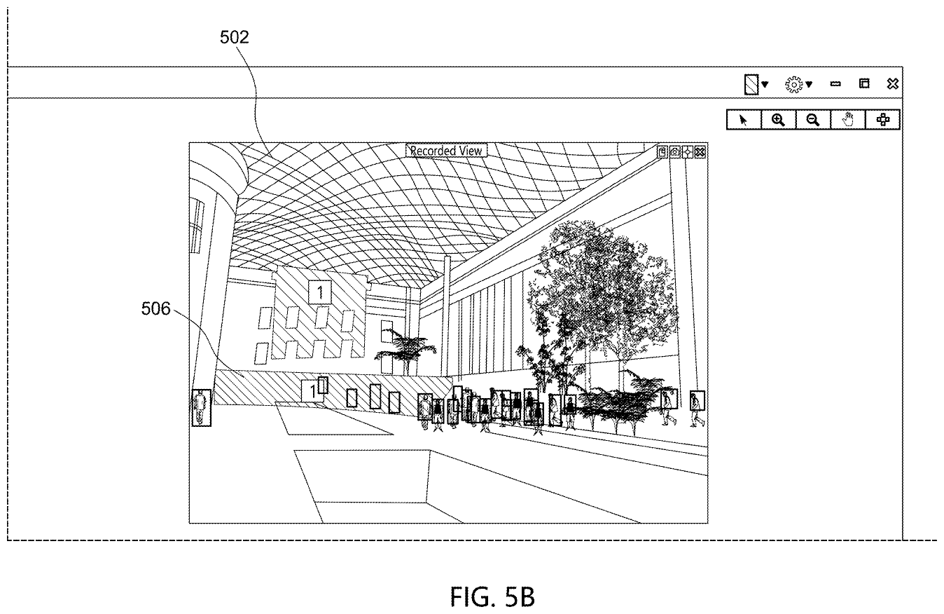

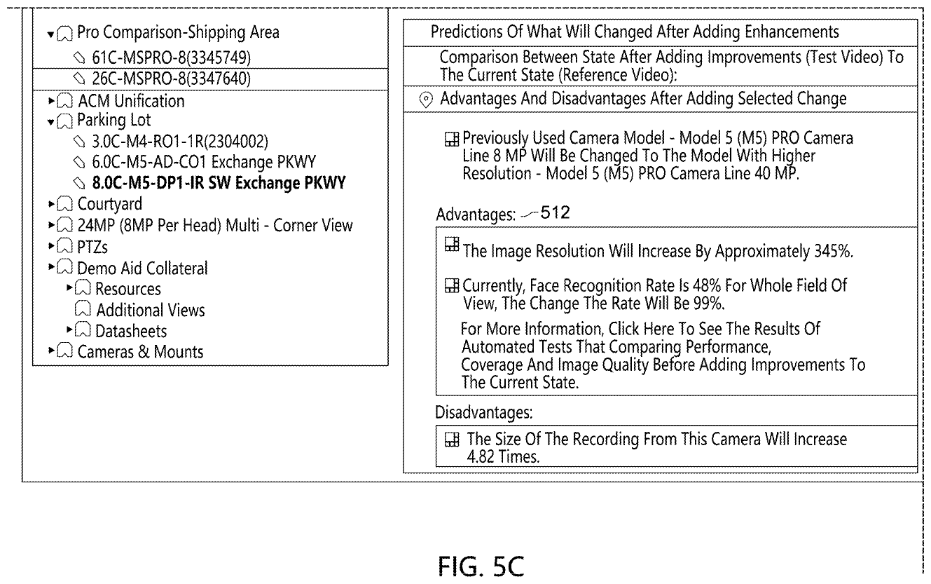

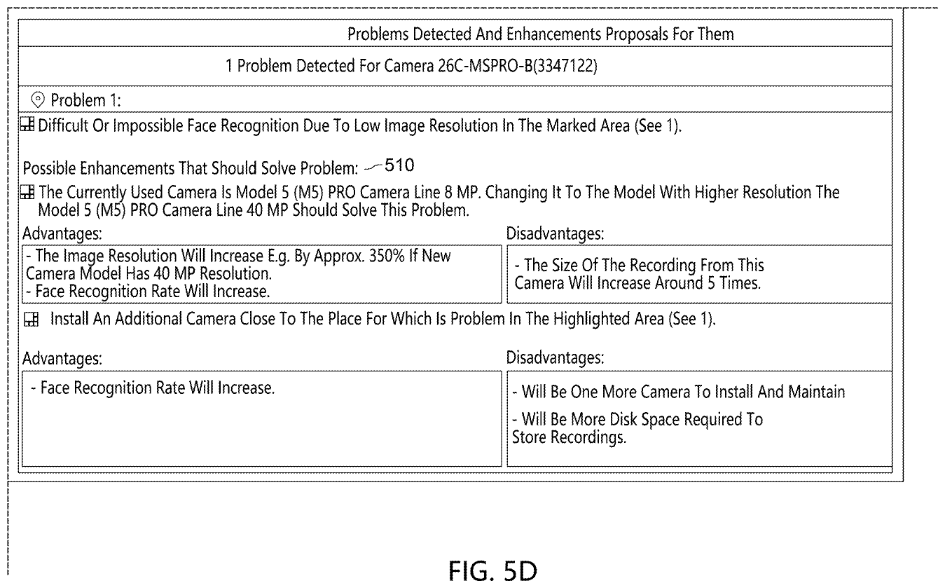

FIGS. 5A-5D are partial views of an example screen of the graphical user interface 300. As shown in FIGS. 5A-5D, the graphical user interface 300 may output the reference video 502 and the test video 504. The graphical user interface 300 may annotate one or more poorly performing areas on the reference video 502, such as area 506, and display recommendations 510 for improving performance of the area 506. In various implementations, the recommendations 510 may include expected advantages and disadvantages associated with implementing the recommendations. As previously described, the test video 504 may be a virtual representation of the expected real-world implementation of the recommendations 510. In addition to outputting the test video 504 (allowing the user to visualize the real-world implementation of the recommendations 510), the graphical user interface 300 may also output quantified advantages and disadvantages 512 associated with implementing the recommendations 510.

In various implementations, the comparison includes outputting the reference video and the test video side-by-side (or in other suitable arrangements) on the graphical user interface 300, allowing the user to visualize the real-world implementation of the recommendation alongside the current media recorded by the current media-recording device 104. In some examples, the comparison includes outputting the reference video analytics data, the test video analytics data, and/or the generated advantages and/or disadvantages on the graphical user interface 300, quantifying the technical benefits and/or drawbacks associated with implementing the recommendation in the real-world.

In the foregoing specification, specific implementations have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementations such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some implementations may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the written description and the claims, one or more steps within any given method may be executed in a different order—or steps may be executed concurrently—without altering the principles of this disclosure. Unless otherwise indicated, the numbering or other labeling of instructions or method steps is done for convenient reference and does not necessarily indicate a fixed sequencing or ordering. In the figures, the directions of arrows generally demonstrate the flow of information—such as data or instructions. However, the direction of an arrow does not imply that information is not being transmitted in the reverse direction. The phrase “at least one of A, B, and C” should be construed to indicate a logical relationship (A OR B OR C), where OR is a non-exclusive logical OR, and should not be construed to mean “at least one of A, at least one of B, and at least one of C.”

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some implementations, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices—such as computing devices interconnected by one or more networks or other communications systems.

In the claims, if an apparatus or system is claimed as including one or more electronic processors (and/or other elements) configured in a certain manner (for example, to make multiple determinations), the claim or claimed element should be interpreted as meaning one or more of the electronic processors (and/or other elements) where any combination of the one or more electronic processors (and/or other elements) may be configured to make some or all of the multiple determinations—for example, collectively. To reiterate, those electronic processors and the processing may be distributed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various implementations for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A camera system comprising:
an electronic processor configured to:
generate a three-dimensional scene including static assets and dynamic assets, the static assets and the dynamic assets representative of an environment and objects within a reference video, the reference video representing a first perspective,
animate the dynamic assets based on motions of the objects within the reference video to generate an animated scene,
render a test video based on the animated scene, the test video representing a second perspective,
generate video analytics data of the test video,
generate a comparison based on the video analytics data of the test video and video analytics data of the reference video, and
transform a graphical user interface according to the comparison.

2. The camera system of claim 1, wherein the electronic processor is further configured to:
label the objects within the reference video;
track positions of the labeled objects;
generate object tracking data based on the positions of the labeled objects; and
animate the dynamic assets based on the object tracking data.

3. The camera system of claim 1, wherein the electronic processor is further configured to:
generate video analytics of the reference video; and
in response to the video analytics being below a threshold, generate a recommendation based on the video analytics,
wherein the second perspective is determined based on the recommendation.

4. The camera system of claim 3, wherein:
the recommendation includes a change in a spatial position of a camera used to record the reference video; and
the second perspective is determined based on the change in the spatial position of the camera.

5. The camera system of claim 3, wherein:
the recommendation includes a change in an optical zoom level of a camera used to record the reference video; and
the second perspective is determined based on the change in the optical zoom level of the camera.

6. The camera system of claim 3, wherein:
the recommendation includes a change in a sensor resolution of a first camera used to record the reference video; and
the test video simulates a recording from a second camera having the changed sensor resolution.

7. The camera system of claim 3, wherein:
the recommendation includes moving or removing a selected object from the reference video, the video analytics data indicating that the selected object reduces a performance of the reference video; and
rendering the test video includes moving or removing a selected asset from the animated scene, the selected asset corresponding to the selected object.

8. The camera system of claim 3, wherein:
the recommendation includes modifying illumination conditions of the reference video; and
rendering the test video includes adjusting illumination assets of the animated scene based on the recommendation.

9. The camera system of claim 3, wherein:
the recommendation includes updating a firmware of a camera used to record the reference video; and
the test video simulates a recording from the camera having the updated firmware.

10. The camera system of claim 3, wherein:
the recommendation includes a deployment of at least one new camera; and
the test video simulates a recording from the at least one new camera.

11. The camera system of claim 10, wherein:
the camera used to record the reference video and the at least one new camera include panning capabilities, tilting capabilities, and zooming capabilities;
the at least one new camera includes upgraded operational parameters compared to the camera used to record the reference video; and
the upgraded operational parameters include at least one of a camera pan range, a camera tilt range, or an optical zoom level of the at least one new camera.

12. The camera system of claim 10, wherein:
the camera used to record the reference video is a single-head camera; and
the at least one new camera is a multi-head camera.

13. The camera system of claim 10, wherein:
the camera used to record the reference video includes first operational parameters;
the at least one new camera includes second operational parameters; and
the second operational parameters includes an increase in resolution over a resolution of the first operational parameters.

14. The camera system of claim 10, wherein:
the camera used to record the reference video includes first operational parameters;
the at least one new camera includes second operational parameters; and
the second operational parameters includes a different optical zoom level than an optical zoom level of the first operational parameters.

15. A computer-implemented method of generating a camera configuration, the method comprising:
generating, at a rendering engine, a three-dimensional scene including static assets and dynamic assets, the static assets and the dynamic assets representative of an environment and objects within a reference video, the reference video representing a first perspective;
animating, at the rendering engine, the dynamic assets based on motions of the objects within the reference video to generate an animated scene;
rendering, at the rendering engine, a test video based on the animated scene, the test video representing a second perspective;
generating, at an analytics engine, video analytics data of the test video;
generating, at the analytics engine, a comparison based on the video analytics data of the test video and video analytics data of the reference video; and
transforming, at the analytics engine, a graphical user interface according to the comparison.

16. The computer-implemented method of claim 15, further comprising:
labeling, with an object detection model, the objects within the reference video;
tracking, with an object tracking model, positions of the labeled objects; and
generating, with the object tracking model, object tracking data based on the positions of the labeled objects,
wherein the dynamic assets are animated based on the object tracking data.

17. The computer-implemented method of claim 15, further comprising:
generating, at the analytics engine, video analytics of the reference video; and
in response to the video analytics being below a threshold, generating, at the analytics engine, a recommendation based on the video analytics,
wherein the second perspective is determined based on the recommendation.

18. The computer-implemented method of claim 17, wherein:
the recommendation includes a change in a spatial position of a camera used to record the reference video; and
the second perspective is determined based on the change in the spatial position of the camera.

19. The computer-implemented method of claim 17, wherein:
the recommendation includes a change in an optical zoom level of a camera used to record the reference video; and
the second perspective is determined based on the change in the optical zoom level of the camera.

20. The computer-implemented method of claim 17, wherein:
the recommendation includes a change in a sensor resolution of a first camera used to record the reference video; and
the test video simulates a recording from a second camera having the changed sensor resolution.
